(19) United States
(12) Patent Application Publication
(10) Pub. No.: US 2021/0203197 A1
(43) Pub. Date: Jul. 1, 2021

(54) STATOR FOR A ROTATING ELECTRICAL MACHINE

(71) Applicant: Moteurs Leroy-Somer, Angouleme Cedex 9 (FR)

(72) Inventors: Jacques Saint-Michel, Angouleme (FR); Xavier Jannot, Angouleme (FR); Francois Turcat, Montignac Sur Charente (FR); Cedric Plasse, Linars (FR); Olivier Gas, Gond-Pontouvre (FR)

(21) Appl. No.: 17/058,554

(22) PCT Filed: May 17, 2019
(86) PCT No.: PCT/EP2019/062829

§ 371 Date: Nov. 24, 2020

(30) Foreign Application Priority Data
Jun. 7, 2018 (FR) 1854967

(51) Int. Cl. H02K 1/16; H02K 15/02; H02K 1/20; H02K 1/14

(52) U.S. Cl. CPC H02K 1/165; H02K 15/024; H02K 2201/15; H02K 1/148; H02K 1/20

(57) ABSTRACT

A stator for a rotary electrical machine including a radially interior ring having teeth and slots which are open radially toward the outside, extending between the teeth, bridges of material connecting two adjacent teeth at their base, and defining the bottom of the slot between these teeth, and a radially exterior yoke, attached in contact with the ring, the ring and the yoke respectively exhibiting first and second reliefs collaborating with one another and/or with one or more inserts, and windings placed in a distributed fashion in the slots.

The present invention relates to rotating electrical machines, and more particularly to the stators of such machines.

In known stators, the yoke forms slots that are fully open or semi-open toward the air gap, so as to allow the windings to be installed. In general, the semi-open slots accept electrical conductors of circular transverse section placed loosely, whereas the fully-open slots house electrical conductors of rectangular transverse section placed in an arranged manner.

JP 2 875497 relates to a stator for an electrical machine comprising a toothed ring of which the laminations have thinned portions in their thickness, these portions being situated between two consecutive teeth on the side of the air gap. Such thinned portions constitute openings toward the air gap which may produce non-insignificant electromagnetic disturbances, notably an increase in the “magnetic” air gap because of flux fringing, iron losses that are greater at the surface of the rotor for the same reason, or else torques that are pulsating because the variations in permeance are relatively sharp. Furthermore, the windings therein are wound onto teeth.

JP 2011-097723 discloses individual teeth attached to a yoke.

Patent application FR 3 019 947 describes a stator comprising a toothed ring comprising teeth connected to one another by bridges of material and defining between them slots for receiving the coils, the slots being open radially toward the outside. The openings of the slots are closed by a yoke attached to the toothed ring.

There is a need to have a rotating electrical machine stator that is easy to assemble and allows efficient filling of the slots, while at the same time providing satisfactory electromagnetic performance. There is also a need to further improve the stators of electrical machines and notably to reduce torque ripple.

Stator

The invention seeks to respond to this need and achieves this, according to one of its aspects, by means of a stator for an electrical machine, comprising:
a radially interior ring comprising teeth and slots which are open radially toward the outside, extending between the teeth, bridges of material connecting two adjacent teeth at their base, and defining the bottom of the slot between these teeth, and
a radially exterior yoke, attached in contact with the ring, the ring and the yoke respectively exhibiting first and second reliefs collaborating with one another and/or with one or more inserts, and
windings placed in a distributed fashion in the slots.

The first and second reliefs preferably complement one another and collaborate through the complementing nature of their shapes. They allow the yoke to be immobilized angularly with respect to the ring and allow the ring and the yoke to be fixed relative to one another, notably circumferentially and also preferably radially.

The ring can thus be stiffened by the yoke, and this may allow the yoke to be produced with slender bridges of material, something which offers numerous advantages as detailed later on. Such a configuration makes it possible to minimize the parasitic air gap between the yoke and the ring.

The presence of the first and second reliefs also makes it possible to increase the surface area of the interface between the ring and the yoke and thus better distribute the flux circulating through the parasitic air gap between the yoke and the ring.

The collaboration between the first and second reliefs and/or with the insert or inserts may be full or partial. In other words, it is possible, without departing from the scope of the present invention, for their respective shapes not to be exactly the same. It is possible for the shapes of the first and second reliefs not to exactly complement one another.

The insert or inserts are different from a winding. The insert or inserts are preferably magnetic and not electrically conducting.

The bridges of material connecting two adjacent teeth at their base and defining the bottom of the slot between these teeth allow the slots to be closed on the side of the air gap. The bridges of material and the teeth are formed as one piece with the rest of the laminations that make up the ring. The presence of the slots that are closed on the side of the air gap make it possible to reinforce the stator mechanically and reduce vibrations because a minimized “cogging torque” effect is obtained, the electromagnetic disturbances being reduced in comparison with a stator of the prior art that has slots which are open onto the air gap.

What is meant by an “attached yoke” is that the yoke is not produced as one piece with the ring but is attached to the latter during the manufacture of the stator.

Yoke-Ring Interface

The first reliefs belonging to the ring may be situated on the teeth, notably at their end facing the yoke. The second reliefs belonging to the yoke may be situated on the interior surface of the yoke, facing the teeth of the ring and, more particularly, facing the first reliefs. They are notably angularly offset with respect to the slots of the ring.

The yoke may comprise third reliefs situated on the interior surface of the yoke, facing the slots of the ring. These third reliefs are notably offset with respect to the teeth of the ring. These third reliefs are not configured to collaborate with the ring when the yoke is attached in contact with the ring.

They may serve for the passage of a flow of cooling fluid, for example a flow of air, for cooling the stator.

In a variant, the third reliefs may serve to house a winding slip shoe that makes the windings easier to introduce into the slots. These shoes may be left in situ or removed. Such shoes may be made of a plastic material. They may extend over the entire axial dimension of the stator, or over a shorter length.

As a further variant, the third reliefs may serve to house one or more temperature probes, making it possible to avoid the need to house these in the slots, and thus allowing more uniform filling of the slots. The stator comprises for example three to six temperature probes.

Finally, these third reliefs may also help with the penetration and correct distribution of an impregnating varnish into the stator.

The first reliefs of the ring may result from the cutting-out of the third reliefs of the yoke. The ring and the yoke may be cut out simultaneously from the one same lamination using a single cutting operation. The first and third reliefs may have exactly complementing shapes.

The third reliefs may have a shape analogous to that of the second reliefs, but slightly larger, so as to allow good collaboration between the first reliefs and the second reliefs, and notably ease of insertion.

In one embodiment, the third reliefs have a radial dimension greater than a radial dimension of the second reliefs, for example from 0.1 to 20% greater, and better still, from 0.2 to 10% greater or even from 0.3 to 5% greater.

In one embodiment, the third reliefs have a circumferential dimension greater than a circumferential dimension of the second reliefs, for example from 0.1 to 20% greater, and better still, from 0.2 to 10% greater or even from 0.3 to 5% greater.

In instances in which the first and second reliefs have one edge at least partially defined by a portion of a circle, the difference between the radii of the circle portions defining the respective edges of the first and second reliefs may be comprised between 2 and 20 tenths of a millimeter, and better still, between 3 and 15, or even between 4 and 10 tenths of a millimeter.

The first and second reliefs may each respectively have a center of curvature. The center of curvature of the first reliefs may be offset toward the axis of rotation of the machine with respect to the center of curvature of the second reliefs, where applicable. Such a configuration may make it possible, when the yoke is being assembled onto the ring, for the first reliefs to be pulled outward, thus ensuring an absence of clearance between ring and yoke. It is also possible in this way to contrive for tension to be applied to the bridges of material connecting the teeth.

The slots of the ring may have rounded corners in the vicinity of the yoke.

The yoke may have cuts at the level of the ends of the slots of the ring, in the vicinity of the yoke. These cuts may make it possible to create rounded corners in the slots of the ring in the vicinity of the yoke, with a cutout which is clean-cut and free of burrs. The first and/or the second reliefs may adopt the shape of a portion of a disk, which notably may extend over an angular extent of around 180°, or over an angular extent greater than 180°, and better still greater than 210°, or even greater than 240°. The other of the first and/or the second reliefs then adopts the form of an indentation in the shape of a portion of a disk, of corresponding shape.

In one embodiment, the first and second reliefs may each alternately adopt the shape of a portion of a disk or of an indentation in the shape of a portion of a disk, in succession about the axis of rotation of the machine. Said disk portion or the corresponding indentation may extend over an angular extent of around 180°, or over an angular extent greater than 180°, and better still greater than 210°, or even greater than 240°.

In a variant, all the first reliefs project into indentations of the second reliefs. In such an embodiment, the first reliefs have the shape of a portion of a disk, and the second reliefs have the form of an indentation in the shape of a portion of a disk.

The second reliefs may have the form of an indentation in which the ends of the teeth are situated. In this case, the ends of the teeth constitute the first reliefs of the ring. The indentation may have a width substantially equal to, notably slightly greater than, the width of the teeth at their free end. The free ends of the teeth may be slightly chamfered to make it easier for them to enter the indentations of the yoke. At the free ends of the teeth, the edges of the teeth may converge slightly in the direction of increasing distance away from the axis of rotation of the machine.

The first and second reliefs may be configured in such a way that the interface between the ring and the yoke has an undulating shape.

The first and second reliefs may have a dovetail and mortise shape. The dovetail may have rounded corners. In one embodiment, the first relief of the ring may have a dovetail shape.

The first and second reliefs may have the shape of a key inserted in a cage. The second reliefs may comprise a rounded protuberance which fits into a rounded cage of the first reliefs. The cage may be delimited by two branches, which may or may not part as the second relief is inserted. The first reliefs may comprise one or more openings, notably on either side of the rounded cage. These openings may be created in the middle of the aforementioned branches. As a variant, it is possible to insert a tool that is conical at the ends of the stator, into one, several, or all of the aforementioned cages, so as to part the branches from one another and lock the assembly between yoke and ring.

Holes may be created at the interface between the ring and the yoke. These holes may serve for the passage of a flow of cooling fluid, for example a flow of air, for cooling the stator. In a variant, they may serve for the passage of through-bolts for holding the stator.

Bridges of Material

The teeth formed between the slots are joined together on the side of the air gap by bridges of material. Thus, each slot is closed on the side of the air gap by a bridge of material connecting together two consecutive teeth of the stator mass. The bridges of material each connect two adjacent teeth at their base on the side of the air gap and define the bottom of the slot between these teeth.

The bridges of material are of one piece with the adjacent teeth.

The absence of opening of the slots toward the air gap makes it possible to avoid producing electromagnetic disturbances, notably an increase in the “magnetic” air gap because of flux fringing, iron losses that are greater at the surface of the rotor for the same reason, or else pulsating torques. The electromagnetic performance of the machine is thereby improved.

Deformable Zone

At least a part of these bridges of material may exhibit at least one deformable zone capable of deforming as the yoke is mounted on the ring and/or as the windings are inserted in the slots.

What is meant by a “deformable zone” is a zone of the bridge of material that deforms as a matter of preference upon relative movement of the teeth that it connects. The deformation of the bridge of material may result in a lengthening or shortening of the circumferential dimension of the bridge of material, this leading to a lengthening or shortening of the circumferential dimension of the ring. The preferential deformation may be the result of a specific shape given to the bridge.

The deformable zone makes it possible to respond to the mechanical stresses experienced by the ring as the ring is being assembled with the yoke. In addition, it makes it possible, if so desired, to have slots that are more widely open prior to the mounting of the yoke and therefore a greater clearance between the windings and the wall of the slots as the windings are being inserted, something which makes winding insertion easier and reduces the risk of damage to the insulation.

The yoke is able to close the slots of the ring and hold the windings in the slots after they have been inserted. During the manufacture of the stator, the yoke may be assembled with the ring in a number of ways. The deformable zones of the bridges of material facilitate this assembly by giving the ring a certain degree of flexibility, which allows it to adapt to the shape of the yoke during the mounting of the latter, the yoke, which is more rigid, imposing its shape.

It is also possible to assemble the ring and the yoke with a clearance between them, and then increase the diameter of the ring by deforming it thanks to the deformable zones, in order to reduce this clearance.

In addition, the presence of the bridges of material reduces the risk of loss of lacquer in the air gap when the complete stator is being impregnated with a lacquer. This makes it possible to reduce the need for cleaning.

It also makes it possible to reduce the leakage of lacquer into the air gap during operation of the machine on which the stator is mounted. This simplifies the maintenance of the machine.

The term “lacquer” should be understood here in a broad sense, including any type of impregnation material, notably polymer.

The deformable zone preferably forms a clearance between the bridge of material and the corresponding winding, something which may make it easier for the lacquer to penetrate when impregnating the stator.

Because the slots are closed after the yoke has been assembled, the risk of impregnation lacquer leaking into the air gap is eliminated. The stator can be used as a closed impregnation chamber simply by providing sealing at the ends of the stator only. The tooling is thus simplified. This also reduces the amount of lacquer lost and the cleaning operations.

Zone of Reduced Magnetic Permeability

The bridges of material may exhibit zones that are magnetically saturated during operation of the machine. This then limits the passage of the flux from one slot to another without in any way preventing the passage of flux from the rotor to the stator.

In order to obtain saturation, it is possible locally to reduce the cross section of the bridge of material that is available for the passage of the flux, for example by providing at least one localized restriction formed by at least one groove.

At least some and, better still, all, the bridges of material may each exhibit at least one zone of reduced magnetic permeability assuming one or more of the following forms:
at least one localized restriction formed by at least one groove extending along the longitudinal axis of the stator in the thickness of the bridge of material or at least one localized crushing of the material in the width of the bridge of material, and/or
at least one opening in the width of the bridge of material, and/or
at least one treatment, notably located within the width of the bridge of material, that locally reduces the magnetic permeability of the bridge of material.

The zone of reduced magnetic permeability which is formed by the localized restriction, the localized crushing, the opening or the localized treatment of the bridge of material allows said zone of the bridge of material to become magnetically saturated when the machine is in operation, thereby limiting the passage of flux and increasing the efficiency of the machine.

This zone of reduced magnetic permeability preferably extends over the entire thickness of the ring. In a variant, the zone of reduced magnetic permeability extends over a length less than or equal to the thickness of the ring.

The zone of reduced magnetic permeability of each bridge of material is preferably continuous in the thickness of the ring, and may or may not be rectilinear.

In a variant, the zone of reduced magnetic permeability is discontinuous in the thickness of the ring.

For example, the ring assumes the form of a stack of laminations, each lamination having teeth joined together at their base on the side of the air gap by bridges of material, at least some and, better still, all, of the bridges of material each exhibiting at least one zone of reduced magnetic permeability. The zones of reduced magnetic permeability of the bridges of material of each of the laminations need not be centered. Each lamination of the stack of laminations may be monobloc.

At least two adjacent laminations may exhibit at least two zones of reduced magnetic permeability arranged in a staggered offset manner with respect to one another, and may or may not partially intersect one another. The offset staggered configuration may be achieved by turning over certain laminations, notably every second lamination, of the stack of laminations that makes up the ring or by cutting the laminations at an angle or by the use of differing laminations.

Each lamination is for example cut from a sheet of magnetic steel, for example steel 0.1 to 1.5 mm thick. The laminations may be coated with an electrically insulating lacquer on their opposite faces prior to being assembled within the stack. The electrical insulation may alternatively be obtained by a heat treatment of the laminations, where applicable.

As a preference, in instances in which the bottom of the slots has at least one groove, the grooves are open toward the slots. The bottom of the slots preferably exhibits a bearing surface, better still, at least two bearing surfaces, oriented transversely and the bottom of the groove is set back with respect to this or these surfaces. The bearing surface or surfaces may be oriented obliquely with respect to the radial axis of the corresponding slot or, as a preference, oriented perpendicularly to this axis. The groove forms a break in slope with respect to the bearing surface or surfaces. The windings, which are preferably substantially rectangular in cross section, inserted into the corresponding slot preferably bear against the bearing surfaces and are set back with respect to the bottom of the groove. As a preference, the windings are not in contact with the groove. The bearing surface or surfaces are preferably planar. The bottom of the slot may be flat, with the exception of the groove. This allows good filling of the slots by the windings in the case of windings of rectangular transverse section, by allowing the windings to rest flat in the bottom of the slots.

The groove in the bottom of the slot preferably forms a clearance between the bridge of material and the corresponding winding, something which may make it easier for the lacquer to penetrate when impregnating the stator.

The bridge of material may comprise at least two grooves as described hereinabove. The groove or grooves may or may not be centered with respect to the slot.

The internal surface of the stator is preferably a cylinder of revolution.

In a variant, the grooves may extend on the internal surface of the stator.

As a preference, the grooves each have a profile that is curved in section on a plane perpendicular to the axis of the stator, notably a section that is substantially semicircular.

The localized crushing may be performed in the thickness of the bridge of material, namely along a radial axis of the stator, and constitutes a localized restriction having reduced magnetic permeability. The crushing preferably forms a groove in the bottom of the slot. In that case, the localized crushing may be as described hereinabove in respect of the grooves.

As a variant, the localized crushing is performed in the thickness of the stator, namely along an axis parallel to the longitudinal axis of the stator, and exhibits reduced magnetic permeability.

The aforementioned opening preferably extends along the longitudinal axis of the stator over the entire thickness of the stator mass. The opening may be oval, circular or polygonal in cross-sectional shape, for example having rounded edges, and notably being rectangular. The bridge of material is able to have just one single opening in its width. The opening may be at the center of the bridge of material. The opening may exhibit two thinner zones one on either side thereof, the thinner zones being magnetically saturated when the machine is in operation.

In a variant, the bridge of material exhibits a plurality of micro-perforations across its width. The microperforations reduce the cross section of the lamination and allow the bridge of material to become magnetically saturated by a lower magnetic flux.

The localized treatment makes it possible locally to modify the permeability of the material of the bridge to the magnetic flux. The localized treatment may extend over the entire width of the bridge of material or over just a portion thereof. This treatment may be a heat treatment which locally modifies the orientation of the grains of metal and leads to a drop in the magnetic permeability in the circumferential direction.

In an alternative, the heat treatment is a thermal stress associated with the degradation of the material during the laser cutting of the bridge of material.

The bridges of material may be nondeformable. This increases the stiffness of the stator and improves the life of the electric machine.

Slots

The fact that the slots are open radially toward the outside allows the windings to be inserted into the slots by a radial movement toward the inside of the slots. This makes installation of the windings easier, on the one hand insofar as access to the inside of the slots is easier, these being slots that are completely open and toward the outside rather than toward the inside, and on the other hand insofar as the space available around the ring, for the necessary tooling, or even for a winding machine, is far greater than the space available in the bore of the stator.

Furthermore, such a stator offers numerous advantages from the electromagnetic point of view in comparison with a stator having slots that are open toward the air gap. It allows a significant reduction in the electromagnetic disturbances associated with the presence of the slots opening onto the air gap in the prior art. Furthermore, because the filling of the slots is easier, the degree of filling can be improved, making it possible to improve the performance of the machine still further. The torque per unit volume can be increased.

The absence of opening of the slots toward the air gap makes it possible to reduce the slot pulsation. The electromagnetic performance of the machine is thereby improved.

At least one slot, and, better still, all the slots, may have mutually parallel opposing edges. This then yields a better degree of filling of the slots. The width of the slots is preferably substantially constant over the entire slot height.

At least one tooth and, better still, all the teeth, may be of trapezoidal overall shape when viewed in section in a plane perpendicular to the axis of the stator. At least one tooth and, better still, all the teeth, may have divergent edges that diverge in the direction away from the axis of rotation of the machine. Such a configuration makes it possible to compensate for the obstacles to the passage of the magnetic flux which obstacles may be connected with the presence of the first and second reliefs collaborating with one another and/or with inserts, with a possible opening, or with the presence of a parasitic air gap at the interface between the yoke and the ring. The shortest width of the tooth may be substantially equal to the size of the interface between the yoke and the ring for which there is close contact, which is to say outside of the first and second reliefs that collaborate with one another and/or with inserts, or of any orifice there might be.

As a preference, all the bridges of material each have at least one deformable zone. This makes it possible to vary the diameter of the ring over a broader range of values and achieve more uniform magnetic properties.

As a preference, each bridge of material has a single deformable zone.

The deformable zones may or may not be centered within the corresponding bridge of material

As a preference, each deformable zone has the form of a fold defining at least one channel on one of the sides of the bridge of material, for example the side facing toward the air gap, and a relief projecting from the opposite side. As a preference, the channels are open toward the air gap and the projecting reliefs extend into the bottom of the slot.

As a preference, the projecting reliefs extend into a recess in the bottom of the corresponding slot, the projecting reliefs notably being inferior or equal in height to the depth of said recess. This makes it possible to prevent the reliefs from extending beyond the bottom of the slot, thereby making the slot easier to fill with the windings. As a preference, after the bridge of material has been deformed, the height of the projecting reliefs remains less than or equal to the depth of said recess.

The bridges of material having a deformable region may have a median axis, when the stator is observed along the axis of rotation, that is curved or in the form of a broken line, notably in the form of an arch or of a V.

In a variant, the deformable zone is a zone of the bridge of material that can be stretched and deformed by stretching, to form a striction when the ring is being mounted on the yoke and/or when the windings are being inserted in the slots.

As a preference, the deformable zones are zones of the bridge of material that are magnetically saturated during operation of the machine. This improves the passage of the electromagnetic flux between the slots and the air gap, making it possible to minimize harmonics and obtain more torque through desaturation of the teeth and of the yoke.

As a preference, the bottom of the slots each have at least one planar portion against a winding, preferably of substantially rectangular cross section, bears. The planar portion or portions are substantially perpendicular to the radial axis of the slot.

The bottom of the slot may be flat, with the exception of a recess. This allows good filling of the slots by the windings in the case of windings of rectangular transverse section, by allowing the windings to rest flat in the bottom of the slot.

In a variant, the bottom of the slot may be completely flat and the bridge of material may be deformed by stretching to form a striction, as mentioned above.

The deformable zone or the recess preferably forms a clearance between the bridge of material and the corresponding winding, something which may make it easier for a lacquer to penetrate when impregnating the stator.

The ring may be produced by winding into a helix a strip of sheet metal comprising teeth which are connected by the bridges of material, the opposing edges of each slot preferably becoming substantially mutually parallel when the strip is wound on itself to form the ring.

In a variant, the strip may be formed of sectors each comprising several teeth, the sectors being connected by links, these sectors being cut from a strip of sheet metal. The links may be flexible bridges connecting the sectors to one another and/or parts of complementary shapes, for example of the dovetail and mortise type, or complementing reliefs that come to bear against one another, notably when the ring is held in compression by the yoke. The complementing shapes may be on the bridges of material so that the various sectors become assembled at the level of the bridges of material. As a preference, the assembling of the complementing shapes of the various sectors is performed away from the deformable zones of the bridges of material. This makes assembly easier, notably in the case of very large machines.

For example, sectors exhibiting recessed shapes collaborate with complementing projecting shapes belonging to adjacent sectors.

In a variant, the ring comprises a stack of precut magnetic laminations.

In a further variant, the ring is manufactured using additive manufacturing, for example using powder sintering.

The yoke may be produced by winding directly into a helix a strip of sheet metal if its width permits this, possibly, or possibly not, accompanied by the forming of suitable slots in said strip of sheet metal at the time of cutting out, so as to facilitate this winding, or by stacking precut magnetic laminations or slices obtained by additive manufacturing, for example by powder sintering.

The sheet-metal strips of the yoke and of the ring may be cut separately or simultaneously, possibly from the one same strip of sheet metal having one or more cuts in common.

The sheet-metal strip or strips may be cut out straight, and then bent.

The yoke is attached to the ring after the windings have been fitted into the slots.

Windings

The windings may be placed in the slots in a concentrated or a distributed manner.

What is meant by “concentrated” is that the windings are each wound around a single tooth.

What is meant by “distributed” is that at least one of the windings passes successively through two non-adjacent slots.

As a preference, the windings are placed in the slots as distributed windings, notably when the number of rotor poles is less than or equal to 8.

The windings each comprise at least one electrical conductor which may, in transverse section, be circular in shape, or in the shape of a polygon with rounded corners, preferably a rectangular shape, this list being nonexhaustive.

When the conductors are circular in transverse section, they may be placed in the slot in a hexagonal stack. When the conductors are polygonal in transverse section, they may be placed in the slot in one or more rows oriented radially. Optimizing the stacking may allow a greater quantity of electrical conductors to be placed in the slots, and thus make it possible to obtain a rotor of higher power, for the same volume

The electrical conductors may be placed randomly in the slots or arranged therein. As a preference, the electrical conductors are arranged in the slots. What is meant by “arranged” is that the conductors are not placed loosely in the slots but are placed therein in an orderly manner. They are stacked in the slots non-randomly, for example being placed in one or more rows of aligned electrical conductors, notably in one or two rows, preferably in a single row.

Insulation

The electrical conductors are preferably electrically insulated from the outside by an insulating coating, notably an enamel.

The windings may be separated from the walls of the slot by insulation, notably by at least one sheet of insulation. Such a sheet of insulation allows better insulating of the windings with respect to the slot.

As the windings are being inserted into the slots, something which is done radially rather than axially, the conductors move on contact with a length of the stator mass which at most corresponds to the depth of the slot. This results in mechanical stresses which are lower than is the case with axial insertion, where the conductors are exposed to movement on contact with the stator mass over a length equal to the axial dimension thereof. As a preference, each slot accepts at least two windings, notably at least two windings from different phases. These two windings may be radially superposed. The two windings may be separated from one another by at least one sheet of insulation, preferably by at least two sheets of insulation.

Each winding may be formed of several turns.

In a variant, the windings are in the form of pins, notably U-shaped (known as “U-pin”) or straight, I-shaped (known as “I-pin”), and in that case comprise a portion in the shape of an I or of a U the ends of which are welded to conductors outside of the corresponding slot.

The stator may be twisted (better known as “skewed”). Such skewing contributes to tightening the windings in the slots and to reducing the slot harmonics.

Machine and Rotor

A further subject of the invention is a rotating electrical machine, such as a synchronous motor or a synchronous generator, comprising a stator as defined hereinabove. The machine may be synchronous or asynchronous. The machine may be a reluctance machine. It may constitute a synchronous motor.

The rotary electrical machine may comprise a rotor. The rotor may be a wound rotor or a permanent-magnet rotor. In instances in which the machine is intended to operate as an alternator, the rotor may be a wound rotor. In instances in which the machine is intended to operate as a motor, the rotor may be a permanent-magnet rotor.

During the manufacture of the machine, the rotor may be connected to the ring of the stator, notably by links of material that make the ring of the stator more rigid during winding. After winding, or else after the stator yoke has been fitted, these links of material are severed in order to allow the rotor to rotate with respect to the stator and allow the machine to be used. The severing may be performed using a beam of electrons.

The links of material may be situated at the level of the stator teeth, for example at every second tooth.

The machine may have a relatively large size. The diameter of the rotor may be greater than 50 mm, better still, greater than 80 mm, being for example comprised between 80 and 500 mm.

The rotor may comprise a rotor mass extending along the axis of rotation and positioned around a shaft. The shaft may comprise means of transmitting torque for driving the rotation of the rotor mass.

The rotor may be mounted with or without an overhang.

The rotor may be produced in several rotor sections aligned in the axial direction, for example three sections. Each of the sections may be offset angularly with respect to the adjacent sections (this being known as “step skew”). The rotor may be skewed.

Method of Manufacture and Machine

A further subject of the invention is a method for manufacturing a stator as defined above, in which the ring and the yoke are cut out simultaneously from the same metal sheet in a single cutting-out operation, then the ring and the yoke are assembled after having offset the yoke and the ring relative to one another in order to cause the first and second reliefs to collaborate.

A step of inserting the windings in the slots of the ring of the stator may be implemented. During this step, at least one winding may be placed in two different non-consecutive slots of the ring of the stator.

The method may comprise a step of deforming the deformable zone or zones as the yoke is mounted on the ring and/or as the windings are inserted in the slots. Such deformation may alter the diameter of the ring and the width of the slots.

The step of inserting the windings into the slots may be implemented in such a way as to widen the slots by extending the bridges of material. This also leads to an increase in the outside diameter of the ring. This makes it easier to insert the windings.

The windings are preferably inserted into the slots by an inward radial movement, the slots being open radially toward the outside.

The step of mounting the yoke on the ring may lead to a reduction in the inside diameter of the ring through a closing-up of the bridges of material. This allows the yoke and the ring to be assembled while maintaining a minimal clearance between them, so as to improve the electrical performance by reducing the sum of the air gaps of the magnetic pole.

As a preference, the method comprises a step of cutting out the ring and the yoke simultaneously from the same metal sheet with one or more cuts in common, notably a single cut. In that case, the mounting of the yoke on the ring may lead to a reduction in the outside diameter of the ring through a closing-up of the bridges of material. This is because when the ring and the yoke are being cut out using a press, stresses are generated and the cut material then relaxes, this causing the material to extend beyond the cutting line and making it difficult for the two parts to be assembled along the common cut in the absence of such bridges.

The method may comprise a step of deforming the deformable zones in order to increase the diameter of the ring so as to reduce any clearance there might be between the ring and the yoke after the step of mounting the yoke on the ring.

Notably in instances in which the bridges of material have no deformable zone, it is possible in a variant to expand the yoke by heating or to shrink the ring by cooling, to make it easier to assemble the yoke on the ring.

### DETAILED DESCRIPTION

The invention may be better understood from reading the following detailed description of nonlimiting exemplary embodiments thereof, and from studying the attached drawing in which:

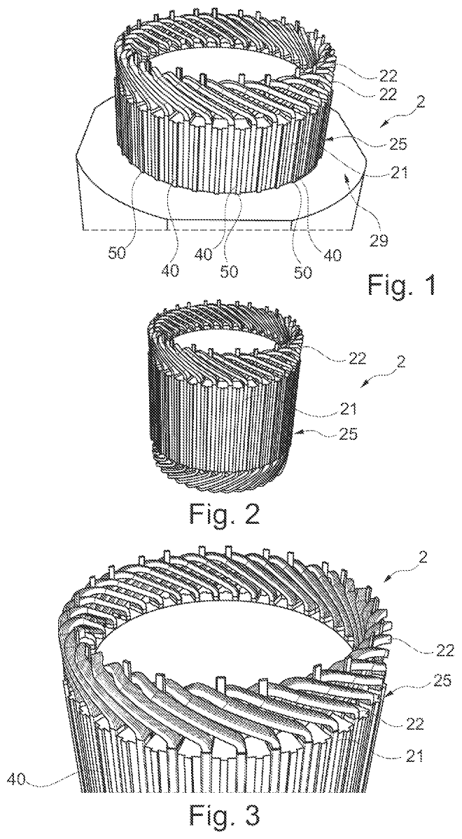

FIG. 1 is a partial and schematic perspective view of a stator produced according to the invention,

FIG. 2 is a partial and schematic perspective view of the ring of the stator of FIG. 1,

FIG. 3 is a detailed view thereof,

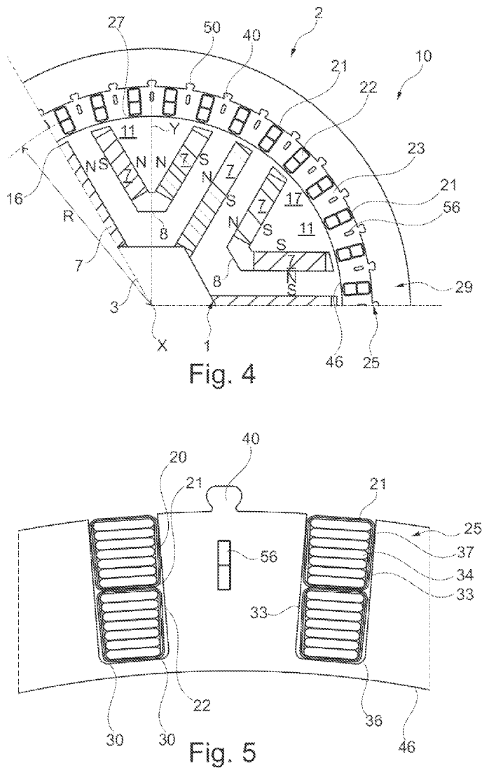

FIG. 4 depicts a partial and schematic view in transverse section of a machine comprising the stator of FIG. 1,

FIG. 5 schematically depicts a portion of the ring of this stator,

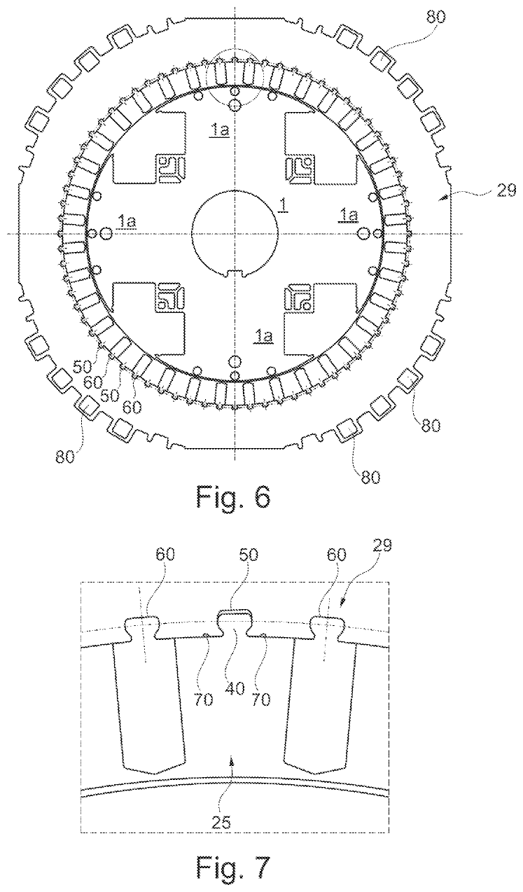

FIG. 6 schematically depicts a variant embodiment of the machine,

FIG. 7 is a detailed view thereof,

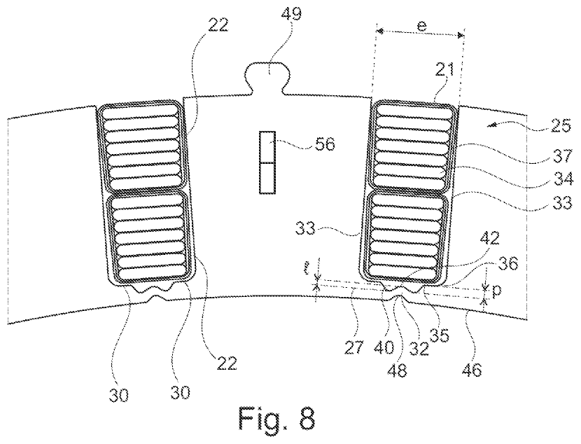

FIGS. 8 to 12 illustrate other variant embodiments of the stator,

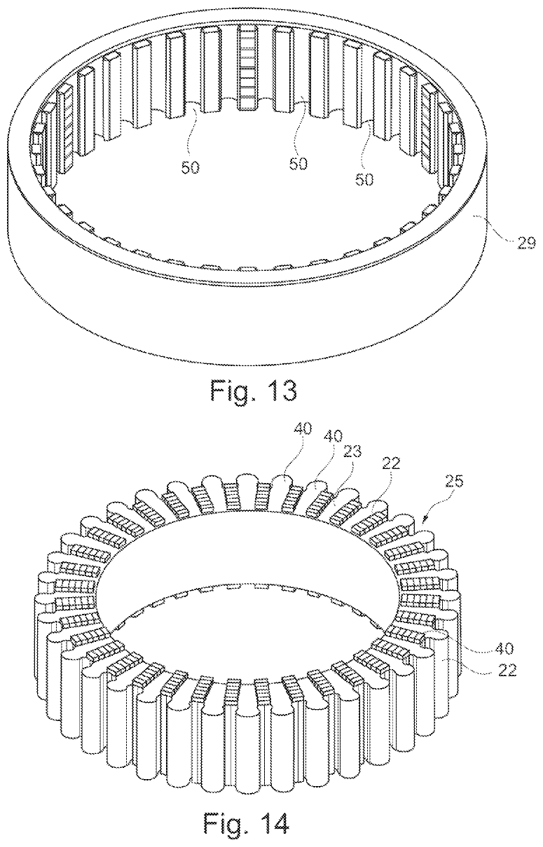

FIGS. 13 and 14 are partial and schematic perspective views of, respectively, the yoke and the ring of a variant embodiment,

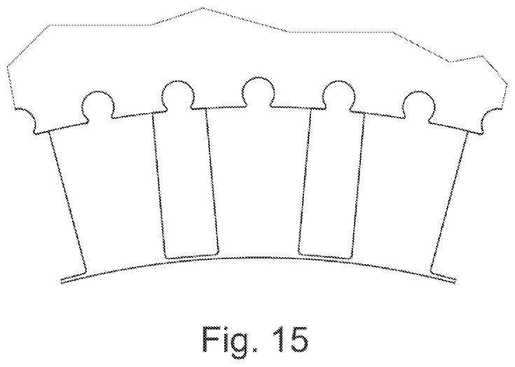

FIG. 15 is a partial and schematic transverse section of a variant embodiment,

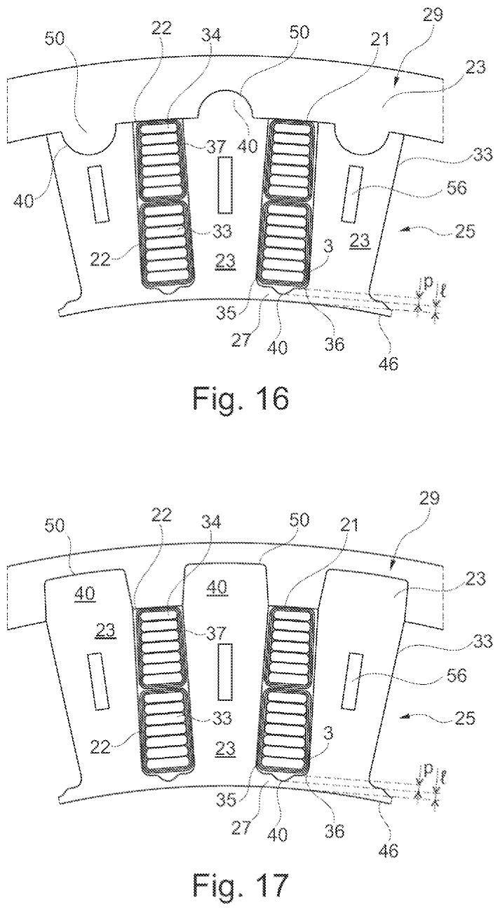

FIGS. 16 to 18 illustrate variant embodiments of the stator,

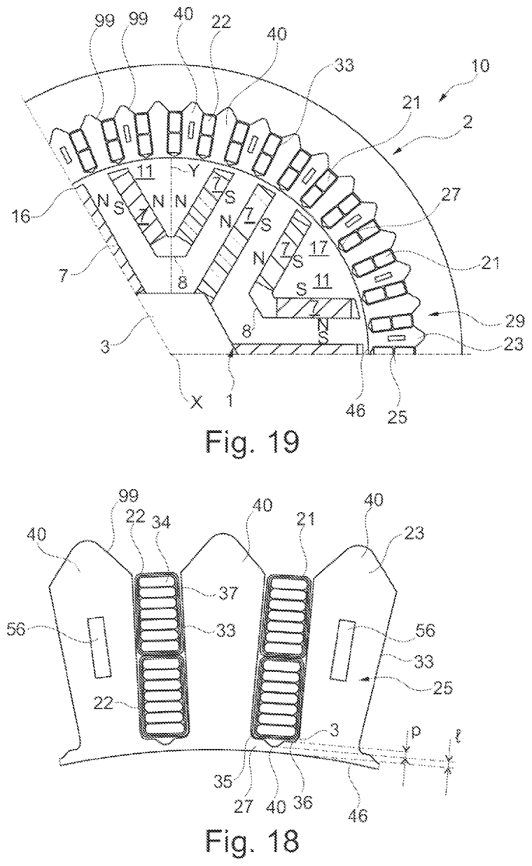

FIG. 19 is a partial and schematic transverse section of the stator of FIG. 18,

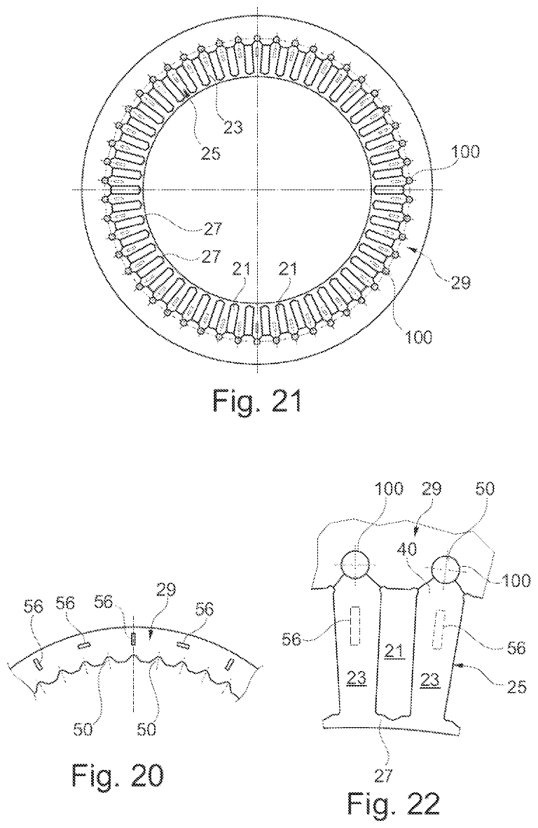

FIG. 20 is a partial and schematic transverse section of the yoke of FIG. 19,

FIG. 21 illustrates another variant embodiment of the stator, and

FIG. 22 is a detailed view thereof.

FIGS. 1 to 5 illustrate a rotary electrical machine 10 comprising a rotor 1 and a stator 2. The stator 2 makes it possible to generate a rotary magnetic field driving the rotation of the rotor 1, in the context of a synchronous motor, and, in the case of an alternator, the rotation of the rotor induces an electromotive force in the stator windings.

The examples illustrated hereinbelow are schematic and are not necessarily depicted to scale.

The stator 2 comprises windings 22 which are placed in slots 21 formed between teeth 23 of a radially interior toothed ring 25. The slots are open radially toward the outside and closed on the side of the air gap by bridges of material 27 each joining together two consecutive teeth of the ring 25 and defining the bottom of the slot between these teeth.

The slots 21, in the example described, have mutually parallel radial edges 33 and, in section in a plane perpendicular to the axis of rotation X of the machine, are substantially rectangular in shape.

The stator 2 comprises a radially exterior yoke 29 attached in contact with the ring 25. The ring 25 and the yoke 29 are each formed of a pack of magnetic laminations which are stacked along the axis X, the laminations being, for example, identical and exactly superposed. They may be held together by clipping, by rivets, by tie rods, by welding and/or by any other technique. The magnetic laminations are preferably made of magnetic steel.

In the example illustrated, the teeth 23 of the ring 25 have complementing reliefs 56 on the surface allowing the various laminations that make up the ring 25 to be clipped together, as visible in FIG. 5.

The ring and/or the yoke may alternatively be formed of a strip of sheet metal cut out and wound on itself.

The yoke 29 is mounted on the ring 25 by collaboration of shapes. The ring 25 and the yoke 29 respectively have first 40 and second 50 reliefs that collaborate to immobilize the yoke 29 with respect to the ring 25. These first 40 and second 50 reliefs are able to provide angular and radial immobilization.

The first reliefs 40 are situated on the external surface of the ring 25, being placed on the teeth, at their end facing the yoke.

The second reliefs 50 are situated on the internal surface of the yoke 29, facing the teeth of the ring and, more particularly, facing the first reliefs. They are angularly offset with respect to the slots of the ring.

The first 40 and second 50 reliefs complement one another and collaborate through complementing shapes to hold the ring and the yoke in position relative to one another.

The windings 22 may be placed in the slots 21 in a concentrated or a distributed manner, preferably a distributed manner. As illustrated in FIG. 5, the electrical conductors 34 of the windings 22 are placed in the slots in an arranged manner. The electrical conductors 34 preferably have a rectangular flattened transverse section and are radially superposed, for example in a single row. The electrical conductors 34 are enameled or coated with any suitable insulating coating.

Each slot 21 is able to accept two stacked windings 22, with different phases. Each winding 22 may, in transverse section, be substantially rectangular in shape.

Each winding 22 is surrounded by a sheet 37 of insulation insulating the windings from the walls 33 and 36 of the slot and the windings 22 of different phases.

The electrical conductors 22 are assembled into windings 22 outside of the slots 21 and are surrounded with a sheet of insulation 27, and the windings 22 with the sheets of insulation 37 are then inserted into the slots 21. This operation is made easier by the fact that the slots are fully open radially toward the outside.

The rotor 1 depicted in FIG. 4 comprises a central opening 5 for mounting a shaft and comprises a magnetic rotor mass 3 extending axially along the axis of rotation X of the rotor, this rotor mass being formed for example by a pack of magnetic laminations stacked along the axis X, the laminations being, for example, identical and exactly superposed. The rotor 1 for example comprises a plurality of permanent magnets 7 placed in housings 8 of the magnetic rotor mass 3. As an alternative, the rotor is a wound rotor.

The stator may be obtained using the method of manufacture which will now be described. The windings 22 are first of all inserted into the slots 21 of the ring 25 by moving the windings 21 radially toward the inside of the slots 21. In a next step, the yoke 29 is forcibly attached to the ring 27 by an axial movement of the one relative to the other, as illustrated in FIG. 1.

In a variant embodiment, the yoke may comprise third reliefs 60 placed on the interior surface of the yoke, facing the slots of the ring, as illustrated in FIGS. 6 and 7. These third reliefs are offset with respect to the teeth of the ring, and do not collaborate with the ring when the yoke is attached in contact with the ring.

They may serve for the passage of a flow of cooling fluid, for example a flow of air, for cooling the stator.

In the example described, the first reliefs 40 of the ring are the result of the cutting-out of the third reliefs 60 of the yoke. The ring and the yoke may be cut out simultaneously from the one same lamination using a single cutting operation. After cutting out, the two resulting strips of sheet metal are offset in order to cause the first reliefs to collaborate with the second reliefs. In the example described, the first and third reliefs have exactly complementing shapes. The third reliefs have a shape analogous to that of the second reliefs, but slightly larger, so as to allow good collaboration between the first reliefs and the second reliefs, and notably easy insertion therein.

Finally, the yoke has cuts 70 at level of the ends of the slots of the ring, in the vicinity of the yoke. These cuts 70 may make it possible to create rounded corners in the slots of the ring in the vicinity of the yoke, with a cutout which is clean-cut and free of burrs.

Furthermore, the yoke comprises external ducts 80 that also allow the circulation of a flow of cooling fluid, for example a flow of air, for cooling the stator.

This example also differs from those previously described in terms of the form of the rotor 1, which in this instance comprises salient poles 1a intended to accept coils which have not been illustrated.

In the example described with reference to FIGS. 1 to 5, the bottom 35 of the slots 21 is of a shape that more or less compliments that of the windings 22, being planar.

In a variant, the bottom of the slots 35 may comprise a recess 40, as illustrated in FIG. 8. In this example, the bottom 35 of the slots 21 has two planar portions 30 one on each side of the recess 40 and against which the rectangular windings 22 bear. The bottom 35 of the slots 21 is connected to the radial edges 33 by fillets 36. The recess 40 takes the form of a longitudinal groove extending along the axis of rotation X of the machine and centered on the bottom of the slot 21.

The recess 40 preferably has a depth p comprised between 0.4 mm and 1 mm, for example equal to 0.6 mm.

The bridges of material 27 preferably each have a deformable zone 32 making it possible to vary their circumferential dimension e, corresponding to the width of the slots 21, and thus vary the mean inside diameter 2R of the ring 25.

In the example illustrated, the deformable zones 32 take the form of folds.

The bridges of material 27 have a variable width, the deformable zones 32 being the zones of smallest width. The smallest width of the bridges of material 27 is preferably comprised between 0.3 mm and 0.6 mm, for example equal to 0.4 mm.

As illustrated in FIG. 8, each fold defines, on one side of the bottom of the slots 35, a projecting relief 42 extending into the recess 40 and, on the side of the air gap 46, a channel 48.

Each projecting relief 42 takes the form of a rib that is rounded at its vertex. It has a height h less than the depth p of the recess 40, so as not to protrude beyond the latter.

The channels 48 take the form of grooves the cross section of which is grounded in a plane perpendicular to the axis X.

When the deformable zones 32 are stretched out, the channels 48 and projecting reliefs 42 flatten down to lengthen the bridge of material and thus widen the slot 21.

When the ring 25 is compressed, the channels 48 and projecting reliefs 42 fold. The projecting reliefs 42 have a height hₘₐₓ greater than the non-deformed height h, and the recesses 40 have a depth pₘₐₓ greater than the non-deformed depth p of recess, the height hₘₐₓ remaining less than the depth pₘₐₓ of the corresponding recess 40.

This stator may be obtained using the method of manufacture which will now be described. The windings 22 are inserted into the slots 21 of the ring 25 by moving the windings 21 radially toward the inside of the slots 21. As the windings 22 are being inserted, the slots 21 may widen through the deformation of the deformable zones of the bridges of material 27. The outside diameter of the ring 25 may thus be larger than before winding. In a next step, the yoke 29 is forcibly attached to the ring 25. This assembly may lead to a reduction in the enlarged outside diameter of the ring 25 by deformation of the deformable zones 32. The clearance between the ring and the yoke is therefore minimal.

In other variant embodiments, the bottom of the slot 21 could have no recess. The projecting reliefs may then be of rounded shape in section on a plane perpendicular to the axis X.

In a further variant, the bottom of the slots 21 could have no recess and the folds could each be formed of a channel facing toward this bottom of the slot 21 and a projecting relief may extend into the air gap 46.

The channels 48 and projecting reliefs 42 may have a profile in the form of a V-shaped broken line and the bottom of the slots 21 is of a width that decreases toward the projecting relief starting from the radial edges 33 of the slots 21.

The deformable zone is a zone which can be stretched and deformed by stretching in order to form a striction. When stretched, the deformable zone 32 may become thinner locally. Prior to the mounting of the yoke, the bridge of material 27 may have a constant thickness.

The bottom of the slot may have two deformable zones 32, as described hereinabove.

In the examples which have just been described, the interface between the yoke and the ring is substantially cylindrical in shape, away from the first and second reliefs which have the overall shape of a dovetail with rounded corners.

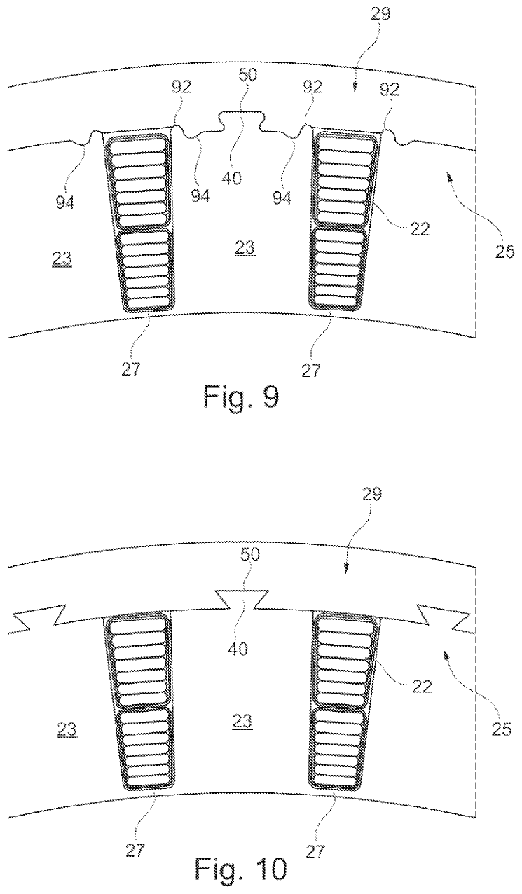

The embodiment of FIG. 9 differs from that of FIGS. 1 to 5 in that the slots in the ring have rounded corners 92 in the vicinity of the yoke. The interface also forms a corrugation 94 that further improves the setting of the angular positioning between yoke and ring.

In another variant embodiment illustrated in FIG. 10, the first 40 and second 50 reliefs have a dovetail and mortise shape, with acute angles in this example.

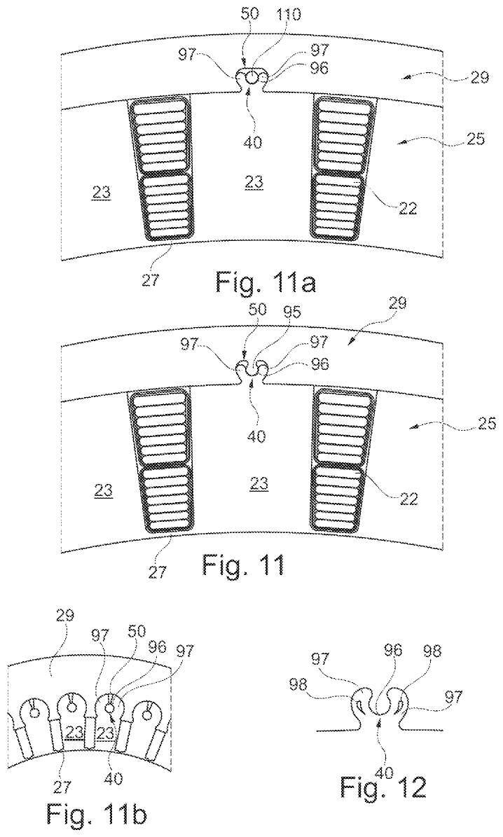

The first 40 and second 50 reliefs may adopt the shape of a key inserted in a cage, as illustrated in FIG. 11. In this example, the second reliefs 50 comprise a rounded protuberance 95 which fits into a rounded cage 96 of the first reliefs 40. The cage 96 may be delimited by two branches 97, which may or may not part as the rounded protrusion 95 of the second relief 50 is inserted.

In a variant, the two branches 97 may part under the action of an insert 110 introduced radially, as illustrated in FIG. 11a.

In the example of FIG. 11b, the two branches 97 of the first relief 40 have the shape of a portion of a disk hollowed out at its center.

The first reliefs may comprise one or more openings 98, as illustrated in the variant of FIG. 12, on either side of the rounded cage 96. These openings 98 may be created in the middle of the aforementioned branches.

In the variant embodiment illustrated in FIGS. 13 and 14, the first reliefs 40 have the shape of a portion of a disk, extending over an angular extent of approximately 260° about a center of curvature. The second reliefs have the form of an indentation in the shape of a portion of a disk, of corresponding shape. The angular extent of the disk portion may be strictly greater than 180°, being notably comprised between 180° exclusive and 300°.

The variant of FIG. 15 differs from FIGS. 13 and 14 through the presence of three reliefs, likewise in the shape of a portion of a disk and extending over an angular extent of approximately 260°.

In the embodiment of FIG. 16, the first 40 and second 50 reliefs each alternately adopt the shape of a portion of a disk or of an indentation in the shape of a portion of a disk, in succession about the axis of rotation of the machine. Said disk portion or the corresponding indentation extend over an angular extent of approximately 180°.

The second reliefs 50 may have the form of an indentation in which the ends of the teeth 23 are situated, as illustrated in FIG. 17. In this case, the ends of the teeth constitute the first reliefs 40 of the ring 25. The indentation has a width slightly greater than the width of the teeth at their free end. The free ends of the teeth are slightly chamfered to make it easier for them to enter the indentations 50 of the yoke 29. At the free ends of the teeth, the edges of the teeth may converge slightly in the direction of increasing distance away from the axis of rotation of the machine.

In the variant embodiment illustrated in FIGS. 18 to 20, the interface between the yoke and the ring forms corrugations 99. For this purpose, the first reliefs 40 have the form of a boss and the second reliefs 50 have the shape of the corresponding indentation.

In the example illustrated, teeth 23 of the ring 25 have complementing reliefs 56 on the surface allowing the various laminations that make up the ring 25 to be clipped together. In this example of FIG. 18, a complementing relief 56 is present on every second tooth. Of course, it would not constitute a departure from the scope of the present invention if all the teeth comprised such complementing reliefs, or if these were present on every third or every fourth tooth for example. The yoke may also comprise some, as illustrated in FIG. 20.

These reliefs 56 may be of oblong overall shape, for example rectangular, and may have a major axis oriented radially, or, in a variant, oriented circumferentially.

Holes 100 may be created at the interface between the ring and the yoke, as illustrated in FIGS. 21 and 22. These holes 100 make it possible to avoid there being sharp edges at the interface. There is maximum contact between the straight edges on each side of the holes 100.

These holes 100 may serve for the passage of a flow of cooling fluid, for example a flow of air, for cooling the stator. In a variant, they may serve for the passage of through-bolts for holding the stator.

The invention is not restricted to these examples of interface between the yoke and the ring, and this interface can be embodied in yet other formats.

The expression “comprising a” should be understood to be synonymous with “comprising at least one”.

1. A stator for a rotary electrical machine, comprising:
a radially interior ring comprising teeth and slots which are open radially toward the outside, extending between the teeth, bridges of material connecting two adjacent teeth at their base, and defining the bottom of the slot between these teeth, and
a radially exterior yoke, attached in contact with the ring, the ring and the yoke respectively exhibiting first and second reliefs collaborating with one another and/or with one or more inserts, and
windings placed in a distributed fashion in the slots.

2. The stator as claimed in claim 1, the first reliefs belonging to the ring being situated on the teeth.

3. The stator as claimed in claim 1, the yoke comprising third reliefs situated on the interior surface of the yoke, facing the slots of the ring.

4. The stator as claimed in claim 3, the first reliefs of the ring being the result of the cutting-out of the third reliefs of the yoke.

5. The stator as claimed in claim 1, the slots having rounded corners in the vicinity of the yoke.

6. The stator as claimed in claim 1, the first and second reliefs respectively each having a center of curvature, the center of curvature of the first reliefs being offset toward the axis of rotation of the machine with respect to the center of curvature of the second reliefs.

7. The stator as claimed in claim 1, the first and/or the second reliefs adopting the shape of a portion of a disk.

8. The stator as claimed in claim 1, the second reliefs having the form of an indentation in which the ends of the teeth are situated.

9. The stator as claimed in claim 1, the first and second reliefs being configured in such a way that the interface between the ring and the yoke has an undulating shape.

10. The stator as claimed in claim 1, the first and second reliefs having a dovetail and mortise shape.

11. The stator as claimed in claim 1, the first and second reliefs having the shape of a key inserted in a cage.

12. The stator as claimed in claim 1, holes being created at the interface between the ring and the yoke.

13. The stator as claimed in claim 1, at least a part of these bridges of material exhibiting at least one deformable zone capable of deforming as the yoke is mounted on the ring.

14. The stator as claimed in claim 1, the bridges of material exhibiting zones that are magnetically saturated during operation of the machine.

15. The stator as claimed in claim 1, the slots having at least one planar portion against which the windings, preferably of substantially rectangular cross section, bear.

16. The stator as claimed in claim 1, the windings each comprising at least one electrical conductor which, in transverse section, is rectangular.

17. A rotary electrical machine comprising a stator as claimed in claim 1 and a rotor.

18. A method for manufacturing a stator as claimed in claim 1, in which the ring and the yoke are cut out simultaneously from the same metal sheet in a single cutting-out operation, then the ring and the yoke are assembled after having offset the yoke and the ring relative to one another in order to cause the first and second reliefs to collaborate.
